(19) United States
(12) Patent Application Publication
(10) Pub. No.: US 2008/0080029 A1
(43) Pub. Date: Apr. 3, 2008

(54) Apparatus, method, and medium for interpolating multiple channels

(75) Inventors: Yun-tae Kim, Yongin-si (KR); Heul-koun Choh, Seongnem-si (KR); Gee-young Sung, Daegu (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-Si (KR)

(21) Appl. No.: 11/892,921

(22) Filed: Aug. 28, 2007

(30) Foreign Application Priority Data
Oct. 2, 2006 (KR) 10-2006-0097339

(51) Int. Cl. H04N 1/46

(52) U.S. Cl. 358/525

(57) ABSTRACT

An apparatus, method, and medium for interpolating multiple channels are provided. The apparatus includes a sensing module which detects a plurality of pixels that are adjacent to a predetermined pixel and comprise a to-be-interpolated channel for the predetermined pixel, and an interpolation module which interpolates the to-be-interpolated channel based on the values of the detected pixels.

### CROSS-REFERENCE TO RELATED APPLICATIONS

This application claims priority benefit of Korean Patent Application No. 10-2006-0097339 filed on October 2, 2006 in the Korean Intellectual Property Office, the disclosure of which is incorporated herein by reference in its entirety.

### BACKGROUND OF THE INVENTION

1. Field of the Invention

The present invention relates to an apparatus, method, and medium for interpolating multiple channels, and more particularly to an apparatus, method, and medium for interpolating multiple channels in which a plurality of channel images can be obtained by interpolating a channel that does not exist in a predetermined pixel based on a plurality of channels that are arrayed in a filter forming a plurality of sub-blocks.

2. Description of the Related Art

Digital camcorders, digital still cameras (DSC), and digital video recorders have become popular, and devices integrating their functions (convergence devices) have been commercialized.

Digital cameras capture color information by using a charged coupled device (CCD) array and an array of color filters that respectively correspond to a plurality of sample points.

### SUMMARY OF THE INVENTION

The present invention provides an apparatus, method, and medium for interpolating multiple channels which a plurality of channel images can be obtained by interpolating a channel that does not exist in a predetermined pixel based on a plurality of channels that are arrayed in a filter forming a plurality of sub-blocks.

According to an aspect of the present invention, there is provided an apparatus for interpolating multiple channels. The apparatus includes a sensing module which detects a plurality of pixels that are adjacent to a predetermined pixel and comprise a to-be-interpolated channel for the predetermined pixel, and an interpolation module which interpolates the channel based on the values of the detected pixels.

According to another aspect of the present invention, there is provided a method of interpolating multiple channels. The method includes detecting a plurality of pixels that are adjacent to a predetermined pixel, and comprise a to-be-interpolated channel for the predetermined pixel, and interpolating the to-be-interpolated channel based on the values of the detected pixels.

According to another aspect of the present invention, there is provided at least one computer readable medium storing computer readable instructions to implement methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram of an apparatus for interpolating multiple channels according to an exemplary embodiment of the present invention;

FIG. 2 is a diagram illustrating the array of six channels in a color filter to form a plurality of sub-blocks according to an exemplary embodiment of the present invention;

FIG. 3 is a diagram for explaining G-channel interpolation according to an exemplary embodiment of the present invention;

FIG. 4 is a diagram for explaining C-channel interpolation according to an exemplary embodiment of the present invention;

FIG. 5 is a diagram for explaining B-channel interpolation according to an exemplary embodiment of the present invention FIG. 6 is a diagram for explaining R-channel interpolation according to an exemplary embodiment of the present invention;

FIG. 7 is a diagram for explaining Y-channel interpolation according to an exemplary embodiment of the present invention;

FIG. 8 is a diagram for explaining M-channel interpolation according to an exemplary embodiment of the present invention; and

FIG. 9 is a flowchart illustrating a method of interpolating multiple channels according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. The invention may, however, be embodied in many different forms and should not be construed as being limited to exemplary embodiments set forth herein; rather, these exemplary embodiments are provided so that this disclosure will be thorough and complete, and will fully convey the concept of the invention to those skilled in the art. Exemplary embodiments are described below to explain the present invention by referring to the figures.

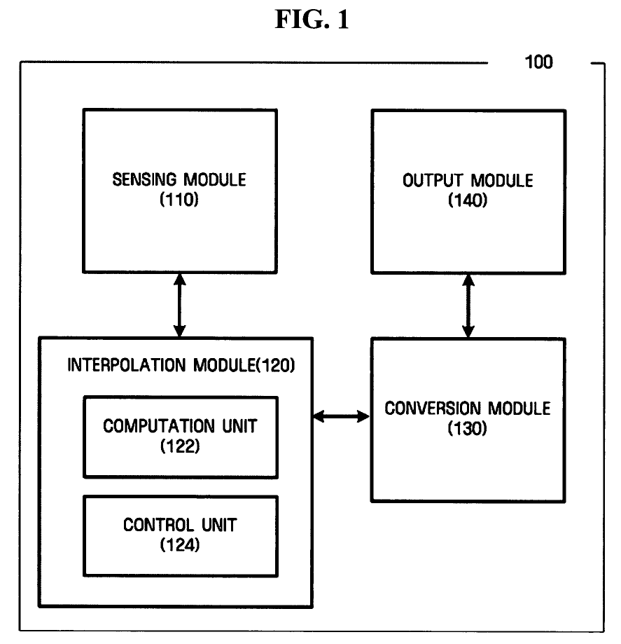

FIG. 1 is a block diagram of an apparatus 100 for interpolating multiple channels according to an exemplary embodiment of the present invention. Referring to FIG. 1, the apparatus 100 includes a sensing module 110, an interpolation module 120, a conversion module 130, and an output module 140. The conversion module 130 and the output module 140 are optional.

The sensing module 110 detects a plurality of pixels that are adjacent to a predetermined pixel, and comprise a to-be-interpolated channel for the predetermined pixel. Each pixel of an image obtained by using a filter comprises information of only one channel. Channel information that the predetermined pixel lacks can be obtained from a plurality of pixels that are adjacent to the predetermined pixel, and this process is referred to as channel interpolation. A filter may comprise six channels, i.e., red (R), green (G), cyan (C), magenta (M), yellow (Y), and blue (B) channels. The R, G, C, M, Y, and B channels may be arrayed in a filter and form a plurality of RGCM and YGCB sub-blocks. According to the present exemplary embodiment, the R, G, C, M, Y, and B channels may be arrayed in the filter. In this case, each of the G and C channels may be arrayed in the filter with twice as many pixels as needed for each of the R, M, Y, and B channels.

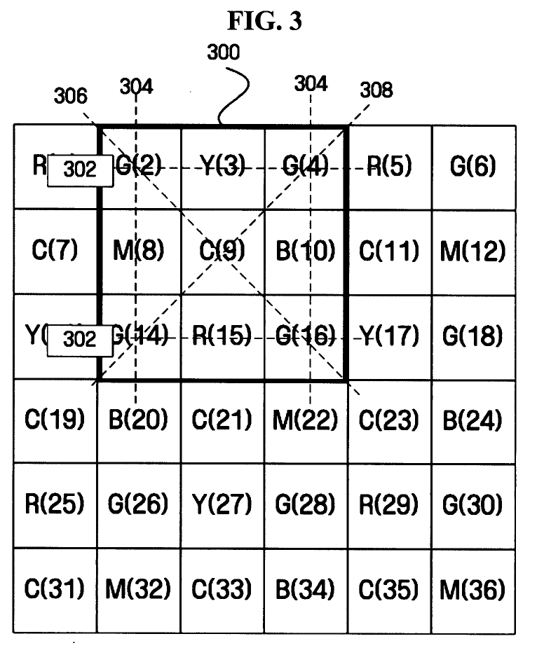

The interpolation module 120 interpolates the to-be-interpolated channel based on the values of the pixels detected by the sensing module 110. The interpolation module 120 includes a computation unit 122 and a control unit 124. The computation unit 122 performs computation on the values of the pixels detected by the sensing module 110. In detail, if more than one pair of pixels is detected adjacent to the predetermined pixel by the sensing module 110, the control unit 124 may compare the difference between the values of one detected pair of pixels with the difference between the values of another detected pair of pixels, and select whichever of the detected pairs of pixels results in a smallest pixel value difference. Then, the computation unit 122 performs computation on the values of the pair of pixels selected by the control unit 124. The operation of the interpolation module 120 will be described later in further detail with reference to FIGS. 3 through 8.

The conversion module 130 converts an image obtained by channel interpolation into an RGB image.

The output module 140 displays an image obtained by the conversion module 130 on a screen.

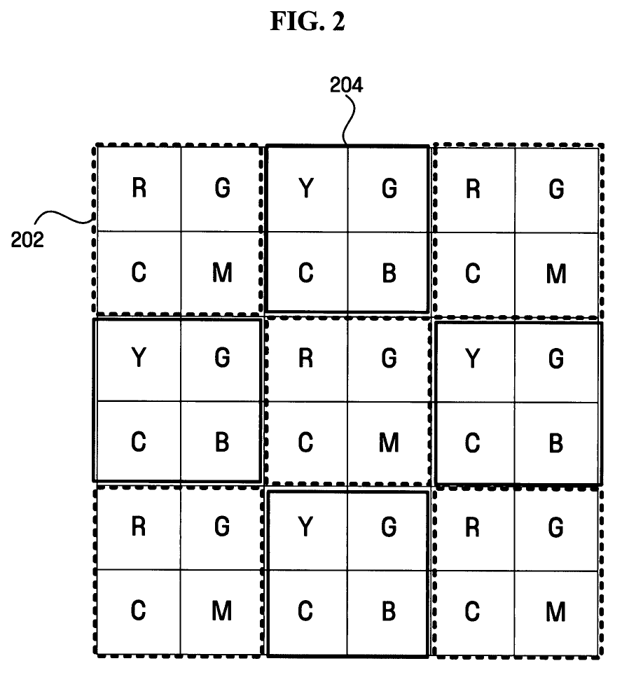

FIG. 2 is a diagram for illustrating the array of six channels in a color filter to form a plurality of sub-blocks, according to an exemplary embodiment of the present invention. Referring to FIG. 6, a total of six channels, i.e., R, G, C, M, Y, and B channels, are arrayed in a color filter (hereinafter referred to as the filter). A plurality of RGCM sub-blocks 202 and YGCB sub-blocks 204 are formed using the R, G, C, M, Y, and B channels. Since the G and C channels comprise more luminance information than the R, M, Y, and B channels, each of the G and C channels may be arrayed in the filter with twice as many pixels as needed for each of the R, M, Y, and B channels.

The R, G, C, M, Y, and B channels are exemplary, and thus the present invention is not restricted thereto. In other words, various types of sub-blocks can be formed using a plurality of channels (e.g., three or more channels) and may then be arrayed in a filter. For example, a filter may comprise seven channels (e.g., R, G, C, M, Y, B, and orange 0 channels or R, G, C, M, Y, B, and purple P channels) or more than seven channels.

In addition, various types of sub-blocks other than the RGCM and YGCB sub-blocks 202 and 204 can be formed using the R, G, C, M, Y, and B channels. For example, a plurality of RGBC and RGBM sub-blocks, a plurality of RGBC and RGBY sub-blocks, or a plurality of RGBC and CMYG sub-blocks can be formed using the R, G, C, M, Y, and B channels, and may then be arrayed in a filter. According to the present exemplary embodiment, the RGCM and YGCB sub-blocks 202 and 204 are arrayed in a filter.

FIG. 3 is a diagram for explaining G-channel interpolation according to an exemplary embodiment of the present invention. Referring to FIG. 3, reference numerals 1 through 36 indicate pixel numbers. In order to perform G-channel interpolation on a 3×3 block 300 which is centered on a ninth pixel, G-channel interpolation must be performed for each of third, eighth, ninth, tenth and fifteenth pixels. Since a pair of pixels (i.e., second and fourth pixels) that are on the opposite sides of the third pixel in a horizontal direction 302 respectively comprise G channels G2 and G4, a G channel G3 for the third pixel can be interpolated by averaging the values of the second and fourth pixels. Likewise, since a pair of pixels (i.e., fourteenth and sixteenth pixels) that are on the opposite sides of the fifteenth pixel in the horizontal direction 302 respectively comprise G channels G14 and G16, a G channel G15 for the fifteenth pixel can be interpolated by averaging the values of the fourteenth and sixteenth pixels. In other words, the G channel G3 can be interpolated using the equation: G3=(G2+G4)/2. The G channel G15 can be interpolated using the equation: G15=(G14+G16)/2. Since a pair of channels (i.e., the second and fourteenth pixels) that are on the opposite sides of the eighth pixel in a vertical direction 304 respectively comprise the G channels G2 and G14, a G channel G8 for the eighth pixel can be interpolated by averaging the values of the second and fourteenth pixels. In other words, the G channel G8 can be interpolated using the equation: G8=(G2+G14)/2. Likewise, a G channel G10 for the tenth pixel can be interpolated using the equation: G10=(G4+G16)/2.

In order to interpolate a G channel G9 for the ninth pixel, an absolute value D_{LR} of the difference between the values of a pair of pixels (i.e., the second and sixteenth pixels) that are on the opposite sides of the ninth pixel in a first diagonal direction 306 and an absolute value D_{RL} of the difference between the values of a pair of pixels (i.e., the fourth and fourteenth pixels) that are on the opposite sides of the ninth pixel in a second diagonal direction 308 are calculated. The absolute value D_{LR} is calculated by the equation: D_{LR}=|G2−G16|. The absolute value D_{RL} is calculated by the equation: D_{RL}=|G4−G14|. Then, the G channel G9 can be interpolated by averaging the values of the pair of pixels corresponding to whichever of D_{LR} and D_{RL} is less than the other. In detail, if D_{LR} is greater than D_{RL}, the G channel G9 may be interpolated using the equation: G9=(G4+G14)/2. If D_{LR} is less than D_{RL}, the G channel G9 may be interpolated using the equation: G9=(G2+G16)/2. If D_{LR} and D_{RL} are the same, the G channel G9 may be interpolated using the equation: G9=(G2+G4+G14+G16)/4.

As described above, in order to interpolate a predetermined channel for a predetermined pixel, the interpolation module 120 may perform computation on the values of a pair of pixels that are on the opposite sides of the predetermined pixel in one of the four directions 302, 305, 306, and 306, and comprise the same channels as the predetermined channel.

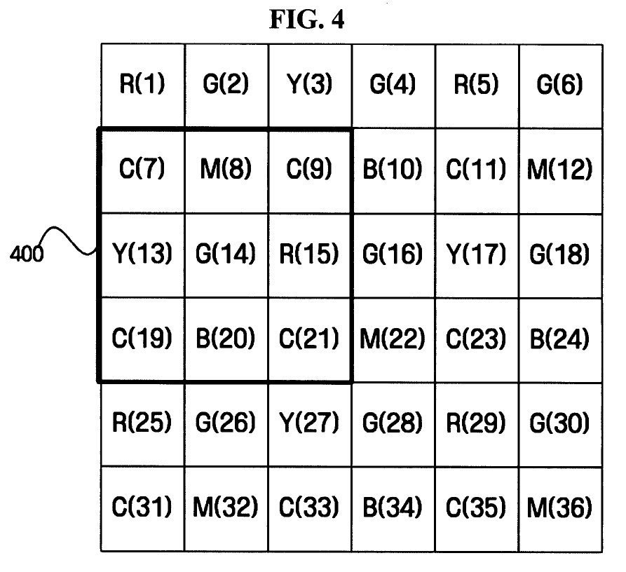

The result of G-channel interpolation can be used to perform C-, B-, R-, Y-, and M-channel interpolation. C-channel interpolation will be described hereinafter in detail with reference to FIG. 4.

FIG. 4 is a diagram for explaining C-channel interpolation according to an exemplary embodiment of the present invention.

C-channel interpolation can be performed using the same principles as those of G-channel interpolation. In detail, in order to perform C-channel interpolation on a 3×3 block 400 which is centered on a fourteenth pixel, G-channel interpolation must be performed for each of the eighth, thirteenth, fifteenth, and twentieth pixels. Since a pair of pixels (i.e., seventh and ninth pixels) that are on the opposite sides of the eighth pixel in a horizontal direction respectively comprise C channels C6 and C9, a C channel C8 for the eighth pixel can be interpolated by averaging the values of the ninth pixels. Likewise, since a pair of pixels (i.e., nineteenth and twenty first pixels) that are on the opposite sides of the twentieth pixel in the horizontal direction respectively comprise C channels C19 and C21, a C channel C20 for the twentieth pixel can be interpolated by averaging the values of the nineteenth and twenty first pixels. In other words, the C channel C8 can be interpolated using the equation: C8=(C7+C9)/2. The C channel C20 can be interpolated using the equation: C20=(C19+C21)/2. Since a pair of channels (i.e., the seventh and nineteenth pixels) that are on the opposite sides of the thirteenth pixel in a vertical direction respectively comprise the C channels C7 and C19, a C channel C13 for the thirteenth pixel can be interpolated by averaging the values of the seventh and nineteenth pixels. In other words, the C channel C13 can be interpolated using the equation: C13=(C7+C19)/2. Likewise, a C channel C15 for the fifteenth pixel can be interpolated using the equation: C15=(C9+C21)/2.

In order to interpolate a C channel C14 for the fourteenth pixel, an absolute value D_{LR} of the difference between the values of a pair of pixels (i.e., the seventh and twenty first pixels) that are on the opposite sides of the fourteenth pixel in a first diagonal direction and an absolute value D_{RL} of the difference between the values of a pair of pixels (i.e., the ninth and nineteenth pixels) that are on the opposite sides of the fourteenth pixel in a second diagonal direction are calculated. The absolute value D_{LR} is calculated by the equation: D_{LR}=|C7−C21|. The absolute value D_{RL} is calculated by the equation: D_{RL}=|C9−C19|. Then, the C channel C14 can be interpolated by averaging the values of the pair of pixels corresponding to whichever of D_{LR} and D_{RL} is less than the other. In detail, if D_{LR} is greater than D_{RL}, the C channel C14 may be interpolated using the equation: C14=(C9+C19)/2. If D_{LR} is less than D_{RL}, the C channel C14 may be interpolated using the equation: C14=(C7+C21)/2. If D_{LR} and D_{RL} are the same, the C channel C14 may be interpolated using the equation: C14=(C7+C9+C19+C21)/4.

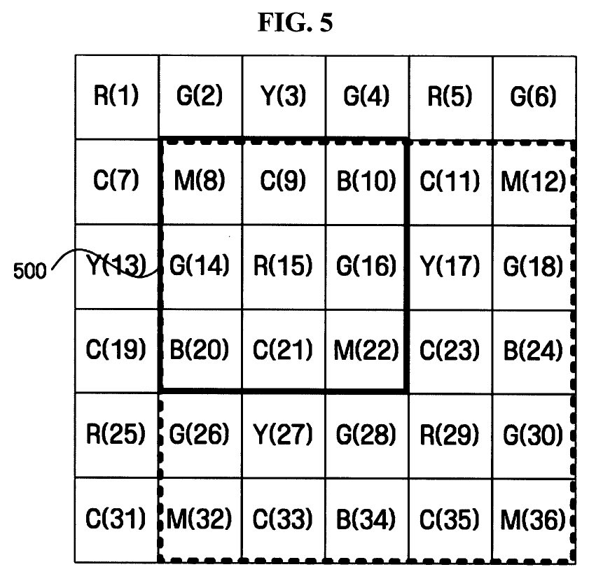

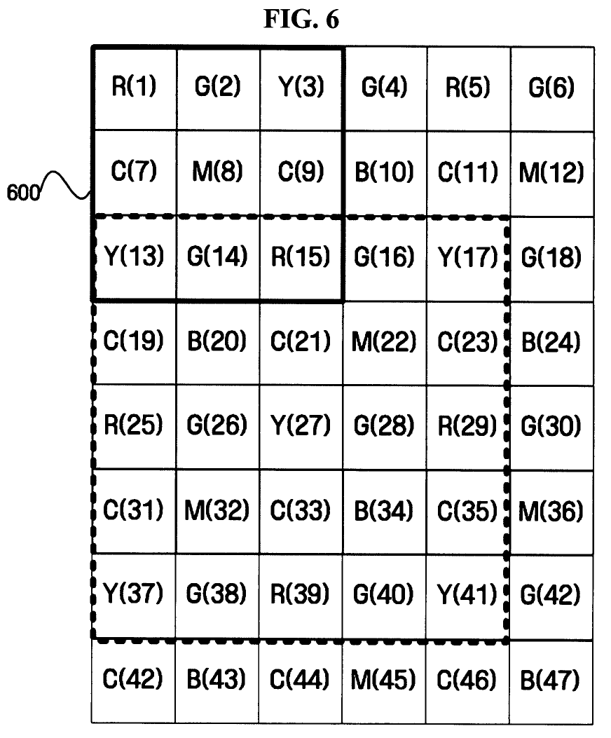

FIG. 5 is a diagram for explaining B-channel interpolation according to an exemplary embodiment of the present invention. Referring to FIG. 5, in order to perform B-channel interpolation on a 3×3 block 500 which is centered on a fifteenth pixel, a difference delta H between the values of a pair of pixels (i.e., twentieth and twenty-fourth pixels) that are on the opposite sides of a twenty-second pixel in the horizontal direction and respectively comprise B components B20 and B24 and a difference delta V between the values of a pair of pixels (i.e., tenth and thirty fourth pixels) that are on the opposite sides of the twenty-second pixel in the vertical direction and respectively comprise B components B10 and B34 are calculated. Since a pair of pixels (i.e., twenty first and twenty-third pixels) that are horizontally adjacent to the twenty-second pixel are respectively affected by the B components B20 and B24 and a pair of pixels (i.e., sixteenth and twenty eighth pixels) that are vertically adjacent to the twenty-second pixel are respectively affected by the B components B10 and B34, delta(Δ) H and delta V may be calculated using the equations: delta H=|B20−B24|+|C21−C23|; and delta V=|B10−B34|+|G16−G28|.

If delta H is greater than delta V, a B channel B22 for the twenty-second pixel may be interpolated using the equation: B22=(B10+B34)/2+(G16−G28)/4. If delta H is less than delta V, the B channel B22 may be interpolated using the equation: B22=(B20+B24)/2+(G21−G23)/4. In other words, the B channel B22 is interpolated based on the pair of pixels corresponding to whichever delta H and delta V is less than the other. If delta H is the same as delta V, the B channel B22 may be interpolated using the equation: B22=(B10+B34+B20+B24)/4+(G16−G28+C21−C23)/8.

Once the B channel B22 is interpolated, a B channel B8 for an eighth pixel is interpolated using the same principles used to interpolate the B channel B22. Then, B channels B9, B21, B14, and B16 can be interpolated using the principles illustrated in FIG. 4, as indicated by the equations: B9=(B8+B10)/2; B21=(B20+B22)/2; B14=(B8+B20)/2; and B16=(B10+B22)/2.

In order to interpolate a B channel B15 for the fifteenth pixel, an absolute value D_{LR} of the difference between the values of a pair of pixels (i.e., an eighth pixel and the twenty-second pixel) that are on the opposite sides of the fifteenth pixel in the first diagonal direction and an absolute value D_{RL} of the difference between the values of a pair of pixels (i.e., the tenth pixel and the twentieth pixel) that are on the opposite sides of the fifteenth pixel in the second diagonal direction are calculated using the equations: D_{LR}=|B8−B22| and; D_{RL}=|B10−B20|. Then, the B channel B15 can be interpolated based on the pair of pixels corresponding to whichever of D_{LR} and D_{RL} is less than the other. In detail, if D_{LR} is greater than D_{RL}, the B channel B15 may be interpolated using the equation: B15=(B10+B20)/2. If D_{LR} is less than D_{RL}, the B channel B15 may be interpolated using the equation: B15=(B8+B22)/2. If D_{LR} is the same as D_{RL}, the B channel B15 may be interpolated using the equation: B15=(B10+B20+B8+B22)/4.

R-, Y-, and M-channel interpolation uses the same principles as B-channel interpolation. R-channel interpolation will hereinafter be described in detail with reference to FIG. 6.

FIG. 6 is a diagram for explaining R-channel interpolation according to an exemplary embodiment of the present invention. Referring to FIG. 6, in order to perform R-channel interpolation on a 3x3 block 600 which is centered on an eighth pixel, a difference delta H between the values of a pair of pixels (i.e., twenty-fifth and twenty-ninth pixels) that are on the opposite sides of a twenty seventh pixel in the horizontal direction and respectively comprise R components R20 and R24 and a difference delta V between the values of a pair of pixels (i.e., fifteenth and thirty ninth pixels) that are on the opposite sides of the twenty-seventh pixel in the vertical direction and respectively comprise R components R15 and R39 are calculated using the equations: delta H=|R25−R29|+|G26−G28|; and delta V=|R15−R39|+|C21−C33|. If delta H is greater than delta V, an R channel R27 for the twenty-seventh pixel may be interpolated using the equation: R27=(R15+R39)/2+(C21−C33)/4. If delta H is less than delta V, the R channel R27 may be interpolated using the equation: R27=(R25+R29)/2+(G26−G28)/4. If delta H is the same as delta V, the R channel R27 may be interpolated using the equation: R27=(R15+R39+R25+R29)/4+(C21−C33+G26−G28)/8.

Once the R channel R27 is interpolated, an R channel R3 for a third pixel and an R channel R13 for a thirteenth pixel are interpolated using the same principles used to interpolate the R channel R27. Then, R channels R2, R14, R7, and R9 can be interpolated using the principles illustrated in FIG. 4, as indicated by the following equations: R2=(R1+R3)/2; R14=(R13+R15)/2; R7=(R1+R13)/2; and R9=(R3+R15)/2.

In order to interpolate an R channel R8 for the eighth pixel, an absolute value D_{LR} of the difference between the values of a pair of pixels (i.e., a first pixel and the fifteenth pixel) that are on the opposite sides of the eighth pixel in the first diagonal direction and an absolute value D_{RL} of the difference between the values of a pair of pixels (i.e., the third and thirteenth pixels) that are on the opposite sides of the eighth pixel in the second diagonal direction are calculated using the equations: D_{LR}=|R1−R15|; and D_{RL}=|R3−R13|. Then, if D_{LR} is greater than D_{RL}, the R channel R8 may be interpolated using the equation: R8=(R3+R13)/2. If D_{LR} is less than D_{RL}, the R channel R8 may be interpolated using the equation: R8=(R1+R15)/2. If D_{LR} is the same as D_{RL}, the R channel R8 may be interpolated using the equation: R8=(R1+R3+R13+R15)/4.

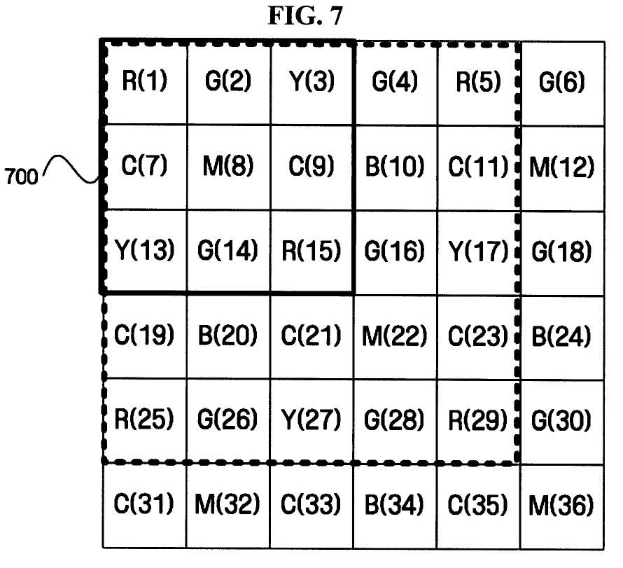

Y-channel interpolation will hereinafter be described in detail with reference to FIG. 7.

FIG. 7 is a diagram for explaining Y-channel interpolation according to an exemplary embodiment of the present invention. Referring to FIG. 7, in order to perform Y-channel interpolation on a 3×3 block 700 which is centered on an eighth pixel, a difference delta H between the values of a pair of pixels (i.e., thirteenth and seventeenth pixels) that are on the opposite sides of a fifteenth pixel in the horizontal direction and respectively comprise Y components Y13 and Y17 and a difference delta V between the values of a pair of pixels (i.e., third and twenty seventh pixels) that are on the opposite sides of the fifteenth pixel in the vertical direction and respectively comprise Y components Y3 and Y27 are calculated using the equations: delta H=|Y13−Y17|+|G14−G16|; and delta V=|Y3−Y27|+|C9−C21|. If delta H is greater than delta V, a Y channel Y15 for the fifteenth pixel may be interpolated using the equation: Y15=(Y3+Y27)/2+(C9−C21)/4. If delta H is less than delta V, the Y channel Y15 may be interpolated using the equation: Y15=(Y13+Y17)/2+(G14−G16)/4. If delta H is the same as delta V, the Y channel Y15 may be interpolated using the equation: Y15=(Y3+Y27+Y13+Y17)/4+(C9−C21+G14−G16)/8.

Once the Y channel Y1 5 is interpolated, a Y channel Y1 for a first pixel is interpolated. Then, Y channels Y2, Y14, Y7, and Y9 can be interpolated using the principles illustrated in FIG. 4, as indicated by the following equations: Y2=(Y1+Y3)/2; Y14=(Y13+Y15)/2; Y7=(Y1+Y13)/2; and Y9=(Y3+Y15)/2.

In order to interpolate a Y channel Y8 for the eighth pixel, an absolute value D_{LY} of the difference between the values of a pair of pixels (i.e., the first pixel and the fifteenth pixel) that are on the opposite sides of the eighth pixel in the first diagonal direction and an absolute value D_{YL} of the difference between the values of a pair of pixels (i.e., the third and thirteenth pixels) that are on the opposite sides of the eighth pixel in the second diagonal direction are calculated using the equations: D_{LY}=|Y1−Y15|; and D_{YL}=|Y3−Y13|. Then, if D_{LY} is greater than D_{YL}, the Y channel Y8 may be interpolated using the equation: Y8=(Y3+Y13)/2. If D_{LY} is less than D_{YL}, the Y channel Y8 may be interpolated using the equation: Y8=(Y1+Y15)/2. If D_{LY} is the same as D_{YL}, the Y channel Y8 may be interpolated using the equation: Y8=(Y1+Y3+Y13+Y15)/4.

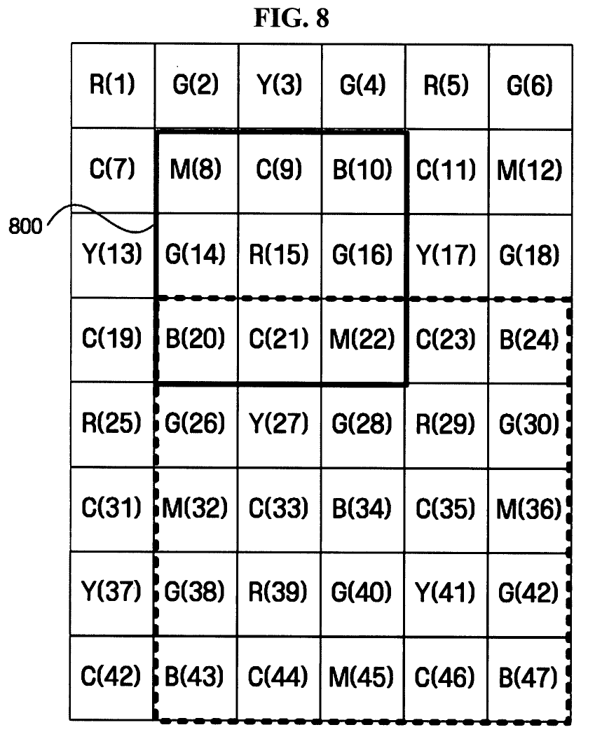

M-channel interpolation will hereinafter be described in detail with reference to FIG. 8.

FIG. 8 is a diagram for explaining M-channel interpolation according to an exemplary embodiment of the present invention. Referring to FIG. 8, in order to perform M-channel interpolation on a 3×3 block 800 which is centered on a fifteenth pixel, a difference delta H between the values of a pair of pixels (i.e., thirty second and thirty sixth pixels) that are on the opposite sides of a thirty fourth pixel in the horizontal direction and respectively comprise M components M32 and M36 and a difference delta V between the values of a pair of pixels (i.e., twenty-second and forty fifth pixels) that are on the opposite sides of the thirty fourth pixel in the vertical direction and respectively comprise M components M22 and M45 are calculated using the equations: delta H=|M32−M36|+|G33−G35|; and delta V=|M22−M46|+|G28−G40|. Then, if delta H is greater than delta V, an M channel M34 for the thirty-fourth pixel may be interpolated using the equation: M34=(M22+M46)/2+(G28−G40)/4. If delta H is less than delta V, the M channel M34 may be interpolated using the equation: M34=(M32+M36)/2+(G33−G35)/4. If delta H is the same as delta V, the M channel M34 may be interpolated using the equation: M34=(M22+M46+M32+M36)/4+(G28−G40+G33−G35)/8.

Once the M channel M34 is interpolated, an M channel M10 for a tenth pixel and an M channel M20 for a twentieth pixel are interpolated. Then, M channels M9, M21, M14, and M16 can be interpolated using the principles illustrated in FIG. 4, as indicated by the equations: M9=(M15+M10)/2; M21=(M20+M22)/2; M14=(M15+M20)/2; and M16=(M10+M22)/2.

In order to interpolate an M channel M15 for the fifteenth pixel, an absolute value D_{LM} of the difference between the values of a pair of pixels (i.e., an eighth pixel and the twenty-second pixel) that are on the opposite sides of the fifteenth pixel in the first diagonal direction and an absolute value D_{ML} of the difference between the values of a pair of pixels (i.e., the tenth pixel and the twentieth pixel) that are on the opposite sides of the fifteenth pixel in the second diagonal direction are calculated using the equations: D_{LM}=|M8−M22| and; D_{ML}=|M10−M20|. Then, the M channel M15 can be interpolated based on the pair of pixels corresponding to whichever of D_{LR} and D_{RL} is less than the other. In detail, if D_{LM} is greater than D_{ML}, the M channel M15 may be interpolated using the equation: M15=(M10+M20)/2. If D_{LM} is less than D_{ML}, the M channel M15 may be interpolated using the equation: M15=(M8+M22)/2. If D_{LM} is the same as D_{ML}, the M channel M15 may be interpolated using the equation: M15=(M8+M10+M20+M22)/4.

An image obtained by the channel interpolation illustrated in FIGS. 3 through 8 may be converted into an RGB image, and the RGB image may be displayed on a screen. The conversion of an image obtained by channel interpolation may be performed using Equation (1):

$$[ \begin{matrix}X \\ Y \\ Z\end{matrix} ] = [ \begin{matrix}{X}_{max , {S}_{1}} & {X}_{max , {S}_{12}} & ⋯ & {X}_{max , {S}_{1 N}} \\ {Y}_{max , {S}_{1}} & {Y}_{max , {S}_{12}} & ⋯ & {Y}_{max , {S}_{1 N}} \\ {Z}_{max , {S}_{1}} & {Z}_{max , {S}_{12}} & ⋯ & {Z}_{max , {S}_{1 N}}\end{matrix} ] [ \begin{matrix}{S}_{1} \\ {S}_{2} \\ ⋮ \\ {S}_{N}\end{matrix} ] + [ \begin{matrix}{X}_{bias} \\ {Y}_{bias} \\ {Z}_{bias}\end{matrix} ] \qquad ( 1 )$$

Where Sᵢ (where i=1, 2, . . . , N) indicates an i-th primary channel (e.g., an R, G, B, C, M, or y channel), [X_{bias} Y_{bias} Z_{bias}] indicates XYZ bias tristimulus values, and [X_{max,S}_{ₜ} Y_{max,S}_{ₜ} Z_{max,S}_{ₜ}] indicates maximum XYZ bias tristimulus values of the i-th primary channel Sᵢ.

Once XYZ tristimulus values of each primary channel are determined using Equation (1), they are converted into RGB values using a conversion matrix, and an image obtained by the conversion is displayed on a screen. The conversion matrix is as indicated by Equation (2):

$$[ \begin{matrix}R \\ G \\ B\end{matrix} ] = [ \begin{matrix}3.2406 & - 1.5372 & - 0.4986 \\ - 0.9689 & 1.8758 & 0.0415 \\ 0.0557 & - 0.2040 & 1.0570\end{matrix} ] [ \begin{matrix}X \\ Y \\ Z\end{matrix} ] . \qquad ( 2 )$$

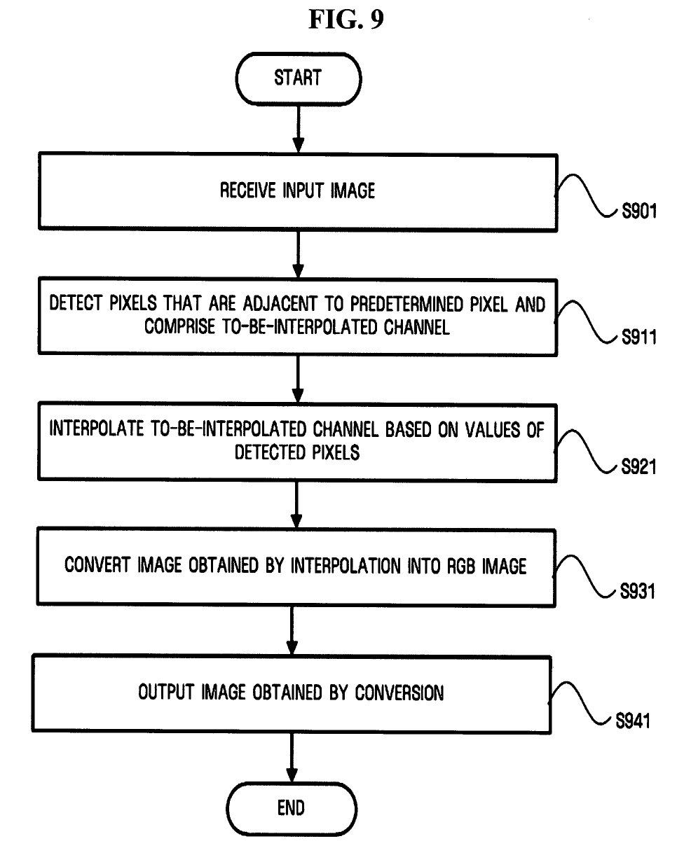

FIG. 9 is a flowchart illustrating a method of interpolating multiple channels according to an exemplary embodiment of the present invention. A total of six channels, i.e., R, G, C, M, Y, and B channels, are arrayed in a filter and form a plurality of RGCM and YGCB sub-blocks. Each of the G and C channels may be arrayed in the filter with twice as many pixels as needed for each of the R, M, Y, and B channels.

Referring to FIG. 9, in operation S901, an image is input to a filter. In operation S911, the sensing module 110 detects a plurality of pixels that are adjacent to a predetermined pixel and comprise a to-be-interpolated channel for the predetermined pixel upon the receipt of the image.

In operation S921, the interpolation module 120 interpolates the to-be-interpolated channel based on the values of the detected pixels. In operation S921, if more than one pair of pixels is detected in operation S911, the interpolation module 120 may interpolate the to-be-interpolated channel based on whichever of the detected pairs of pixels results in a smallest pixel value.

In operation S931, the conversion module 130 converts an image obtained by the interpolation performed in operation S921 into an RGB image. In operation S941, the output module 140 displays an image obtained by the conversion performed in operation S931 on a screen.

As described above, according to the present invention, it is possible to provide wide gamut input images, to realize colors with high precision, and to effectively perform illumination spectrum-based auto white balancing and object reflection-based skin color detection.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be one or more processors.

The computer readable code/instructions and computer readable medium/media may be those specially designed and constructed for the purposes of the present invention, or they may be of the kind well-known and available to those skilled in the art of computer hardware and/or computer software.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An apparatus for interpolating multiple channels, the apparatus comprising:
a sensing module which detects a plurality of pixels that are adjacent to a predetermined pixel and comprise a to-be-interpolated channel for the predetermined pixel; and
an interpolation module which interpolates the to-be-interpolated channel based on values of the detected pixels.

2. The apparatus of claim 1, wherein the multiple channels are arrayed in a filter and form a number of RGCM and YGCB sub-blocks.

3. The apparatus of claim 2, wherein the multiple channels comprise R, G, C, M, Y, and B channels.

4. The apparatus of claim 3, wherein each of the G and C channels is arrayed in the filter with twice as many pixels as needed for each of the R, M, Y, and B channels.

5. The apparatus of claim 1, wherein the interpolation module interpolates a G channel, and then interpolates the rest of the multiple channels based on information obtained by the interpolation of the G channel.

6. The apparatus of claim 1, wherein the interpolation module interpolates the to-be-interpolated channel based on whichever of a plurality of pairs of pixels that are adjacent to the predetermined pixel results in a smallest pixel value difference.

7. The apparatus of claim 1, further comprising a conversion module which converts an image obtained by the interpolation performed by the interpolation module into an RGB image.

8. A method interpolating multiple channels, the method comprising:
detecting a plurality of pixels that are adjacent to a predetermined pixel, and comprise a to-be-interpolated channel for the predetermined pixel; and
interpolating the to-be-interpolated channel based on values of the detected pixels.

9. The method of claim 8, wherein the multiple channels are arrayed in a filter and form a number of RGCM and YGCB sub-blocks.

10. The method of claim 9, wherein the multiple channels comprise R, G, C, M, Y, and B channels.

11. The method of claim 10, wherein each of the G and C channels is arrayed in the filter with twice as many pixels as needed for each of the R, M, Y, and B channels.

12. The method of claim 8, wherein the interpolation comprises interpolating a G channel, and then interpolating the rest of the multiple channels based on information obtained by the interpolation of the G channel.

13. The method of claim 8, wherein the interpolation comprises interpolating the to-be-interpolated channel based on whichever of a plurality of pairs of pixels that are adjacent to the predetermined pixel results in a smallest pixel value difference

14. The method of claim 8, further comprising converting an image obtained by the interpolation into an RGB image.

15. The method of claim 14, further comprising displaying the RGB image.

16. The apparatus of claim 7, further comprising an output module which displays the RGB image provided by the conversion module.

17. At least one computer readable medium storing computer readable instructions that control at least one processor to implement the method of claim 8.

18. The apparatus of claim 1, wherein the apparatus is a digital imager.
